(19) United States
(12) Patent Application Publication
(10) Pub. No.: US 2010/0017317 A1
(43) Pub. Date: Jan. 21, 2010

(54) HANDLING OF OPEN RESERVATIONS IN REAL-TIME ENVIRONMENT

(75) Inventors: Andreas Abrahamsson, Karlskrona (SE); Niclas Anglert, Karlskrona (SE)

Correspondence Address: NIXON & VANDERHYE, PC, 901 NORTH GLEBE ROAD, 11TH FLOOR, ARLINGTON, VA, 22203, US

(73) Assignee: Telefonaktiebolaget LM Ericsson (publ), Stockholm (SE)

(21) Appl. No.: 12/274,658

(22) Filed: Nov. 20, 2008

Related U.S. Application Data
(60) Provisional application No. 61/081,622, filed on Jul. 17, 2008.

(51) Int. Cl. G06Q 30/00; H04M 11/00; G06Q 50/00

(52) U.S. Cl. 705/34; 455/406

(57) ABSTRACT

A method of operating a communications system comprises, during a communications session involving a user of the communications system, making one or more reservations toward a postpaid account for a user, the postpaid account for the user being maintained in a real time account record. The method further comprises, upon receipt of a trigger signal, in conjunction with the reservation(s) assessing the account for the user only for the reservation(s) which have been evaluated by an interrogation. The method also comprises, upon close of billing period for the session, in conjunction with any yet-evaluated reservation(s): (1) assessing the account for the user only for a part of the yet-evaluated reservation(s) that is actually utilized; and (2) deleting from the account for the user any unused part of the yet-evaluated reservation(s).

This application claims the priority and benefit of U.S. provisional patent application 61/081,622, filed Jul. 17, 2008, entitled “HANDLING OF OPEN RESERVATIONS IN REAL-TIME ENVIRONMENT”, which is incorporated by reference herein in its entirety.

### TECHNICAL FIELD

This invention pertains to communications, and particularly to methods and apparatus for accounting and/or charging for services rendered by communications companies and utilized by communication customers.

### BACKGROUND

Communications companies (e.g., telecommunications operators) issue financial charges to customers in return for services rendered. The revenue realized by communications companies upon customer payment (whether in advance or after service) defrays, among other things, the initial capital outlay and maintenance of the network infrastructure, as well as day-to-day operating costs.

Most customers have an account which is established by a contract or fee arrangement/agreement. Some customers may pay a flat fee for communications services. For other customers a customer account is typically structured or arranged, at least in part, so that the customer is assessed a communications fee which is dependent upon an amount of time or other network resource which is utilized by the customer (e.g., degree or quality of service, calendar or clock time of service, for example). In the case of a prepaid billing arrangement, the fee or charge typically reduces a prepaid amount existing in the customer's account. Alternatively, in a postpaid arrangement the fee or charge typically accumulates against the credit of the customer and is presented for subsequent payment.

For charging purposes the communications network provides some type of monitoring of resource consumption by the customers. The monitoring can occur at faculties or nodes involved in setup or administration of the services (e.g., of a call or connection). The resource monitoring and/or other types of reports from the communications network are communicated to a real-time charging system which associates the call or session with a customer's account as maintained by the charging system, and may send reports (e.g., Call Detail Record (CDR) files) to a billing/invoice system which is maintained by the communications operator.

Nowadays there is significant incentive to reduce the operating expense (OPEX) and capital expense (CAPEX) for communications operators. One way of expense reduction is to use the same network or system architecture and/or resources to handle both postpaid and prepaid accounts, e.g., a convergence of postpaid and prepaid account handling. One ramification of the convergence is providing a postpaid subscriber with the real-time characteristics afforded by a common Real-Time Revenue Management System.

It is important that a balance in the Real-Time Revenue Management System match a corresponding balance in the Billing/Invoice System at the end of each bill period. This enhances reliability of any prepaid and postpaid convergence system reliable and gives an accurate end-user balance/experience.

Introducing real-time charging for postpaid subscribers causes a difficult situation regarding the balance at closure of a bill period. In some situations, for a communications session involving a postpaid subscriber, one or more “reservations” of network resources are made/scheduled in advance for the session. It is entirely possible that, at the end of a bill period, a session involving the postpaid subscriber may not be completed and that not all reservation(s) for the postpaid subscriber have been utilized. This presents an accounting problem which, if incorrectly handled, could result in funds being moved between bill periods and/or not booked in/to the correct bill period. This situation is very real, since a session can last for hours or even days. And since sessions for different subscribers can last for long time periods, and be different from one subscriber to the next, it is not an option to wait until all ongoing sessions/reservations are ended before closure of bill period.

Thus, an example challenge which attends such convergence, and an object of the technology described hereinafter, is accurate handling of outstanding reservations (due to ongoing charging sessions) when periodic resetting the balance in a Real-Time Revenue Management System at closure of bill period.

### SUMMARY

A method of operating a communications system comprises, during a communications session involving a user of the communications system, making one or more reservations toward an account (pre- or post-paid) for a user, the account for the user being maintained in a real time account record. The method further comprises, upon receipt of a trigger signal, in conjunction with the reservation(s) assessing the account for the user only for the reservation(s) which have been evaluated by an interrogation. The method also comprises, upon close of billing period for the session, in conjunction with any yet-evaluated reservation(s): (1) assessing the account for the user only for a part of the yet-evaluated reservation(s) that is actually utilized; and (2) deleting from the account for the user any unused part of the yet-evaluated reservation(s).

In an example implementation, the method further comprises, at the close of the billing period, resetting a balance for the account for the user

The trigger signal can be a close of billing period trigger signal, a pre-arranged or pre-negotiated trigger signal, and a management trigger signal.

Upon preparing the final report in the last billing period for the session, assessments to the account for the user are also made for the reservation(s) which are evaluated by an interrogation during the last billing period.

Also disclosed is an apparatus, such as an accounts processor, which can take the form of a processor or controller as those terms are herein expansively described, and as such can execute instructions stored on any suitable media or memory in order to perform the operations described herein.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 is a diagrammatic view of an example, generic embodiment of a communications system suitable for handling open reservations in a real-time environment.

FIG. 2 is a diagrammatic view showing basic, example steps or acts involved in a generic method of handling open reservations in a real-time environment.

FIG. 3 is a diagrammatic view depicting a first scenario of handling open reservations in a real-time environment.

FIG. 4 is a diagrammatic view depicting another scenario of handling open reservations in a real-time environment.

FIG. 5 is a diagrammatic view depicting yet another scenario of handling open reservations in a real-time environment.

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. That is, those skilled in the art will be able to devise various arrangements which, although not explicitly described or shown herein, embody the principles of the invention and are included within its spirit and scope. In some instances, detailed descriptions of well-known devices, circuits, and methods are omitted so as not to obscure the description of the present invention with unnecessary detail. All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry embodying the principles of the technology. Similarly, it will be appreciated that any flow charts, state transition diagrams, pseudocode, and the like represent various processes which may be substantially represented in computer readable medium and so executed by a computer or processor, whether or not such computer or processor is explicitly shown.

The functions of the various elements including functional blocks labeled or described as “processors” or “controllers” may be provided through the use of dedicated hardware as well as hardware capable of executing software in association with appropriate software. When provided by a processor, the functions may be provided by a single dedicated processor, by a single shared processor, or by a plurality of individual processors, some of which may be shared or distributed. Moreover, explicit use of the term “processor” or “controller” should not be construed to refer exclusively to hardware capable of executing software, and may include, without limitation, digital signal processor (DSP) hardware, read only memory (ROM) for storing software, random access memory (RAM), and non-volatile storage.

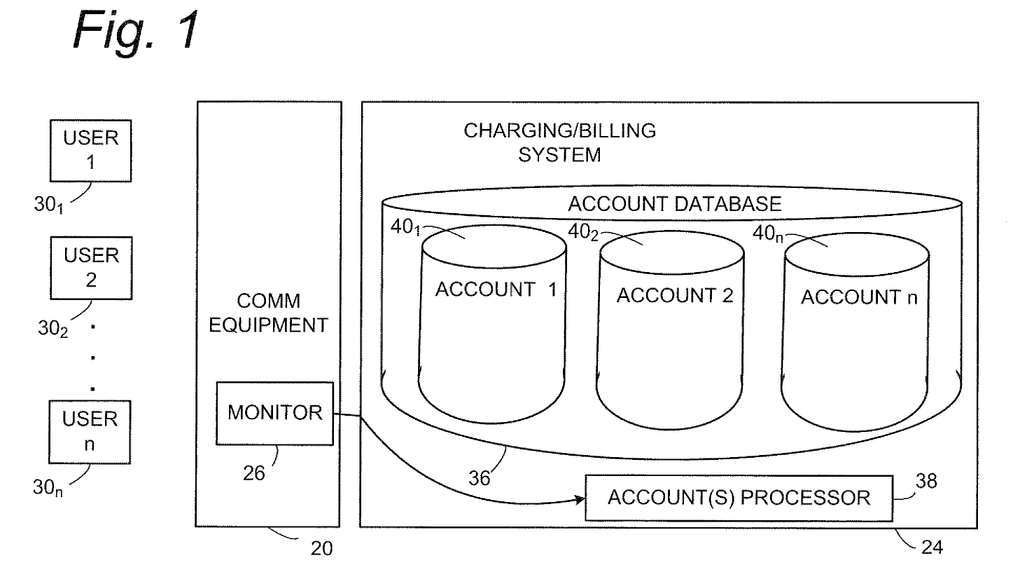

FIG. 1 shows an example communications system comprising a communications network 20 which has access to a real-time charging system and, through the real-time charging system, to a billing system. In the example, non-limiting embodiment shown in FIG. 1, the real-time charging system and the billing system are depicted in consolidated fashion as charging/billing system 24.

The communications network 20 can be or comprise any type or radio access network or other type access network, alone or in combination with one or more core networks, and is typically provided and/or maintained, or is available for use, by a communications company or communications operator (e.g., telecommunications company or telecommunications operator) which provides services to customers or subscribers in exchange for payment. The communications network 20 can thus be or comprise, as examples, a network of a type known as the Universal Mobile Telecommunications (UMTS) Terrestrial Radio Access Network (UTRAN), a Global System for Mobile communications (GSM) type network, an Advance Mobile Phone Service (AMPS) type system; a Narrowband AMPS type system (NAMPS); a Total Access Communications type system (TACS); a Personal Digital Cellular (PDS) type system, an EDGE system, just to name a few different types of radio access networks. The communications system 20 is not limited to wireless communication system but may be any type of, or combination, of data and/or telecommunication systems as fixed line telecommunication networks, IP Multimedia Subsystem (IMS), WLAN, Diameter/Content/Service delivery as specified by 3GPP.

The charging/billing system 24 can, at least in some embodiments, comprise or be included in nodes or elements of communications network 20. However, as shown in FIG. 1, charging/billing system 24 is typically situated at nodes or service points which are external to communications network 20. As used herein, a service point or any other site or facility which performs the functions herein described for charging/billing system 24 are included in the concept of “node”, whether such node or service point is dedicated for the charging/billing function or happens to perform functions in addition to the charging/billing function. Appropriate signaling connections and signaling protocols are established between communications network 20 and charging/billing system 24. For example, communications equipment 20 may send call detail records (CDRs) to charging/billing system 24, or signal in real time to charging/billing system 24.

FIG. 1 illustrates generically (by communications activity monitor 26) a capability of communications system 20 to monitor communications activity, e.g., set-up, termination, and intermediate events for calls and connections involving subscribers, and to obtain and/or signal information to charging/billing system 24 with respect to such activity. Thus, the communications activity monitor 26 communicates with charging/billing system 24 over an appropriate link and/or protocol. The communications activity monitor 26 is configured to consult charging/billing system 24 upon attempted set up of a call or connection (e.g., a transaction) involving a subscriber, and upon approval and successful set up to provide to charging/billing system 24 the information germane to the subscriber or the subscriber's account. Such information can be generated by communications activity monitor 26, not only upon set up of a connection, but also at termination of the call or connection as well as intermediate points (e.g., intermediate interrogations) in between. The information can be (for example) the contact identity CID as user identifier (e.g., MSISDN (Mobile Subscriber Integrated Services Digital Network Number), a SIP URI (Session Initiation Protocol Uniform Resource Identifier), or an email address of the party participating in the call, and can further include or pertain to duration or time of the call or connection, or other aspects or parameters of the call of connection, such as type of service provided, quality of service provided, security or spatial policy, e.g., rights management, etc.

The communications activity monitor 26 can provide such information for multitudinous subscribers. To this end, FIG. 1 shows communications system 20 serving plural users, e.g., users 30₁ through 30ₙ. Moreover, communications activity monitor 26 can provide such information for repeated calls or connections of such users/subscribers on an on-going basis.

The communications activity monitor 26 thus typically represents numerous reporting agents comprising or interspersed within communications network 20, which can be situated at various locations throughout communications network 20. Alternatively, at least in some embodiments, some or all functions of communications activity monitor 26 can also be considered part of charging/billing system 24.

A generic, representative, charging/billing system 24 as shown in FIG. 1 comprises information storage database 36 and accounts processor 38. As further shown in FIG. 1, information storage database 36 comprises plural customer accounts 40, e.g., records for plural customer accounts. For example, account database 36 comprises account 40₁ for customer #1/user 30₁; account 40₂ for customer #2/user 30₂; account 40ₙ for customer #n/user 30ₙ; and so forth. Each account 40 can include, for example, a real-time account balance for the corresponding subscriber/customer/user. For this reason, information storage database 36 is also referred to as real-time account database 36.

The accounts processor 38 serves to handle or manage the accounts 40 in a manner which includes acts hereinafter described, including acts or events associated or involved with handling open reservations in a real-time environment. The accounts processor 38 can also be referred to as an account manager or billing manager, billing controller, or the like. The accounts processor 38 can take the form of a processor or controller as those terms are herein expansively described, and as such can execute instructions stored on any suitable media or memory in order to perform the operations described herein.

The charging/billing system 24 can be consolidated in the manner shown in FIG. 1, or alternatively can be distributed or divided into a separate charging system and a separate billing system. In the distributed/divided embodiments, each user has a separate account in the charging system and the billing system in some example implementations. Moreover, in the distributed/divided embodiments, the accounts processor 38 can be distributed as well, in one manifestation managing the real-time user account in the charging system and in another manifestation managing management and preparation of user bills/invoices in the billing system. See, for example, the following (both of which are incorporated by reference herein): U.S. patent application Ser. No. 12/171,641, filed Jul. 11, 1008, entitled “REAL-TIME FLEXIBLE ACCOUNT SELECTION FOR COMMUNICATIONS”, and U.S. patent application Ser. No. 12/168,083, filed Jul. 4, 2008, entitled “SYNCHRONIZING REAL-TIME AND OFF-LINE ACCOUNTS FOR COMMUNICATIONS”.

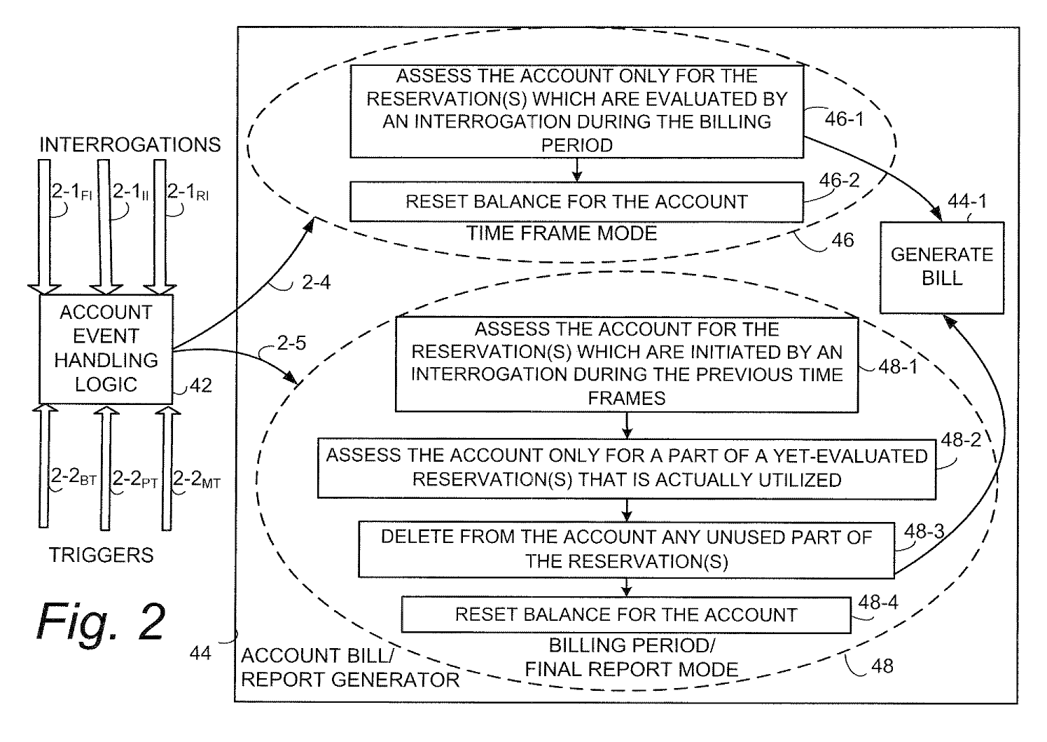

FIG. 2 shows basic, example steps or acts involved in a generic method of operating a communications system during a communications session involving a user of the communications system, and particularly a method of handling open reservations in a real-time environment. FIG. 2 particularly pertains to acts or steps performed in conjunction with the handling of an account for a particular user in conjunction with a communications session involving that particular user. The acts or steps of FIG. 2 can, in an example embodiment, be performed by accounts processor 38, and can be conceptualized as comprising account event handling unit or logic 42 and account bill/report generator 44.

FIG. 2 shows account event handling unit or logic 42 as receiving inputs such as interrogations 2-1 and triggers 2-2. Upon receipt of an interrogation, account event handling unit or logic 42 notes the reservation in the user's account and takes other appropriate actions (e.g., reserving network resources, in some example implementations). An interrogation can be an event or signal (issued by communications activity monitor 26, for example) that includes an indication (or from which logic 42 can conclude) that at least a portion of an existing reservation has been utilized. As shown in FIG. 2, at least three types of interrogations are made toward account event handling logic 42, including first interrogation 2-1_{FI}, one or more intermediate interrogations 2-1_{II}, and a final report interrogation 2-1_{R}I. These interrogations are collectively referenced as interrogation(s) 2-1. A reservation is not extinguished until the account event handling unit or logic 42 makes a determination, on the basis of an evaluation by an interrogation 2-1, that the reservation has been fully utilized. The communications activity monitor 26 can control a session by sending various interrogations 2-1, such as a first interrogation 2-1_{FI}, one or more intermediate interrogations 2-1_{II}, and a final report interrogation 2-1_{RI}. A final report interrogation is also known as an end of session interrogation.

As shown in FIG. 2, account event handling logic 42 receives at least three types of triggers, including a close of billing period trigger 2-2_{BT}, a pre-arranged or pre-negotiated trigger 2-2_{PT}, and a management trigger 2-2_{MT}. A close of billing period trigger (e.g., bill/report trigger) 2-2_{BT} advises account event handling unit or logic 42 that a bill period has ended and/or that a final report for a session should be issued, whereupon an instance of execution of account bill/report generator 44 is commenced for the user account. A pre-arranged or pre-negotiated trigger 2-2_{PT} occurs when a pre-designated event occurs or criteria is reached, for example upon reaching usage of 100 minutes per week. A management trigger 2-2_{MT} is issued when there is to be a change of a parameter such as change in billing period or schedule. A management trigger 2-2_{MT} can be issued internally by the charging system due to, e.g., periodic billing or scheduling adjustments as a part of a campaign or contract (e.g., to adjust timing of a billing period so as to redefine the billing period in case of a contract change or the like), by an offline billing system (which may or may not be integrated with the charging/billing system), or by an external system (such as a provisioning system or customer relations management (CRM) system, which allows an operator to initiate, change, or end the billing period/schedule).

After each of the triggers (e.g., close of billing period trigger 2-2_{BT}, a pre-arranged or pre-negotiated trigger 2-2_{PT}, and a management trigger 2-2_{MT}) generation of a billing report is typically expected. In other words, each of the triggers essentially includes or subsumes a close of a billing period.

FIG. 2 further indicates that account bill/report generator 44 can operate in accordance with either of two modes. A first mode, pointed to from account event handling unit or logic 42 by arrow 2-4, is bill/report generation in conjunction with a time frame mode 46. A second mode, pointed to from account event handling unit or logic 42 by arrow 2-5, is bill/report generation in conjunction with a billing period/final report mode 48.

FIG. 2 further illustrates example, non-limiting acts or steps performed in conjunction with the two modes of account bill/report generator 44. The first mode, e.g., bill/report generation in conjunction with a time frame, comprises act 46-1 and act 46-2. Act 46-1 comprises assessing the account for the user only for the reservation(s) which are evaluated by an interrogation during the same time frame (e.g., j^{th} time frame). As used herein, “assessing” or “assessment” can mean any mathematical operation involved in posting a charge associated with the spent reservation to the user's account, e.g., deducting an amount corresponding to the reservation from the user's account when the amount in the user's account is viewed as a credit balance, or adding an amount corresponding to the reservation from the user's account when the amount in the user's account is viewed as a tally of charges. Act 46-2 comprises resetting the balance for the account after the invoice or bill has been generated, or after information necessary for generating the invoice or bill has been sent to an apparatus or saved for generating the invoice or bill (depicted by act 44-1).

The second mode, e.g., bill/report generation in conjunction with a billing period/final report, comprises act 48-1 through act 48-4. Act 48-1 comprises evaluation of the account for the user for the reservation(s), if any, which are initiated by an interrogation during the previous (j-1) time frames. Act 48-2 comprises assessing the account for the user only for a part of the yet-evaluated reservation(s) that is actually utilized. Act 48-3 comprises deleting from the account for the user any unused part of the yet-evaluated reservation(s). That is, when a time switch is passed in the billing system, the method comprises discarding a remaining portion of the reserved amount (a reservation) that is not consumed, e.g., not returning the balance of the reservation to the subscriber's real-time account. Act 48-4 comprises resetting the balance for the account after the invoice or bill has been generated, or after information necessary for generating the invoice or bill has been sent to an apparatus or saved for generating the invoice or bill (depicted by act 44-1).

It should be understood that myriad other activities and acts can be performed by account event handling unit or logic 42 and/or account bill/report generator 44. For sake of brevity and clarity, only those directly germane to the technology disclosed herein are described herein and illustrated in FIG. 2.

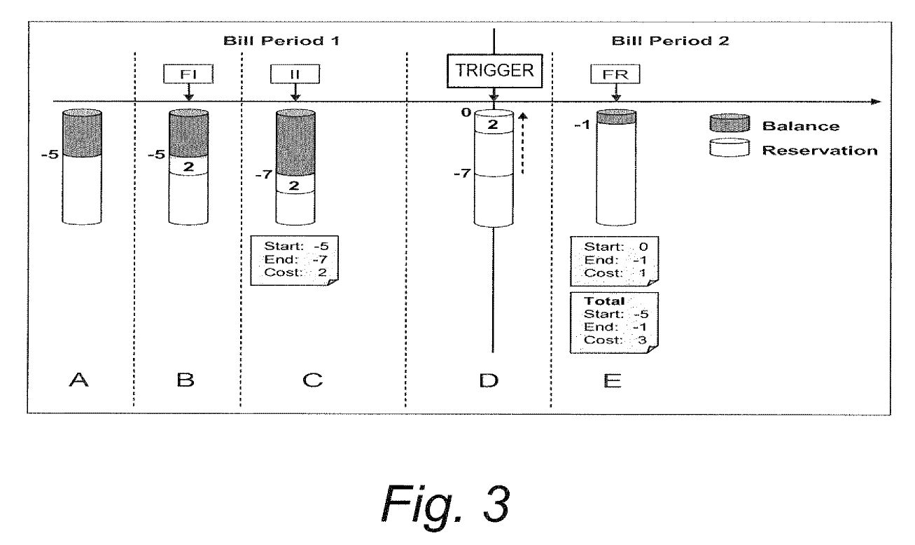

FIG. 3 illustrates a first example scenario of handling open reservations in a real-time environment. FIG. 3 particularly illustrates a situation in which a negative balance is applied on the subscribers account. It should be appreciated that the negative balance situation is just an illustrative example—the balance could either be positive or negative in other scenarios. For sake of description, FIG. 3 is divided into five frames (e.g., time frames) or operation intervals, e.g., frame A through frame E. Frame A through frame D occur in a first bill period (e.g., Bill Period 1), with frame D being included in or comprising the close of the first bill period. Frame E occurs in a second bill period (e.g., Bill Period 2).

Frame A of FIG. 3 shows an initial balance in a user's account as being −5 units. Frame B reflects a start of a communication session involving the user, including a first interrogation (FI) to the user's account for making a reservation of 2 units. Frame C of FIG. 3 reflects a further interrogation(s) (II) to the user's account, at which time the previous reservation of 2 units is evaluated (e.g., deducted, leaving a frame C-ending balance of −7 units) and for making a further reservation of another 2 units. Frame D of FIG. 3 occurs upon a bill-trigger for causing close of a billing period. In accordance with the bill/report generation in conjunction with a non-last billing period mode 46 as shown in FIG. 3, the user's account is assessed only with respect to the reservations which were evaluated by an evaluation, e.g., by a reservation processed by an intermediate or final interrogation during the billing period. Such evaluation occurred, for example, in frame C of FIG. 3, which left the balance for the account at −7 units. The account is closed in frame D upon receipt of a close of billing period trigger (e.g., trigger 2-2_{BT}). Upon closing of the account in frame D of FIG. 3, the account balance of −7 units is used to generate an bill or invoice (act 44-1), and then the balance reset (act 46-2). As shown in Frame D of FIG. 3, a reservation of 2 units still exists for the account, e.g., the yet-evaluated reservation is untouched, and thus eligible to be evaluated by an interrogation in a subsequent frame. Thus, a close of billing period trigger (e.g., trigger 2-2_{BT}) ends a time frame.

In Frame E of FIG. 3 a final report interrogation for the session is received from monitor 26 which is controlling the session at the communication system 20. This final report is requested by a final report interrogation. In frame E of FIG. 3, only a part of the yet-evaluated reservation has been consumed. In accordance with act 48-2, the user's account is assessed only for the part of the yet-evaluated reservation(s) that is actually utilized. In accordance with act 48-3 the remaining part of the yet-evaluated reservation is deleted. These acts prevent funds from being moved between periods, which is not accepted.

Thus, the cost to an account is only accepted to be booked to the account on the time frame in which the reservation was deducted (not when the reservation was initiated). This means that call detail records (CDRs) are created by the accounts processor 38 after each deduction (e.g., after an intermediate interrogation or a final report interrogation). The total cost is distributed between the time frames according to intermediate call detail records (CDRs).

Thus, FIG. 3 describes a method and technique wherein, when a time switch is passed, the remaining portion of the reserved amount that is not consumed is discarded i.e. not returned to the account.

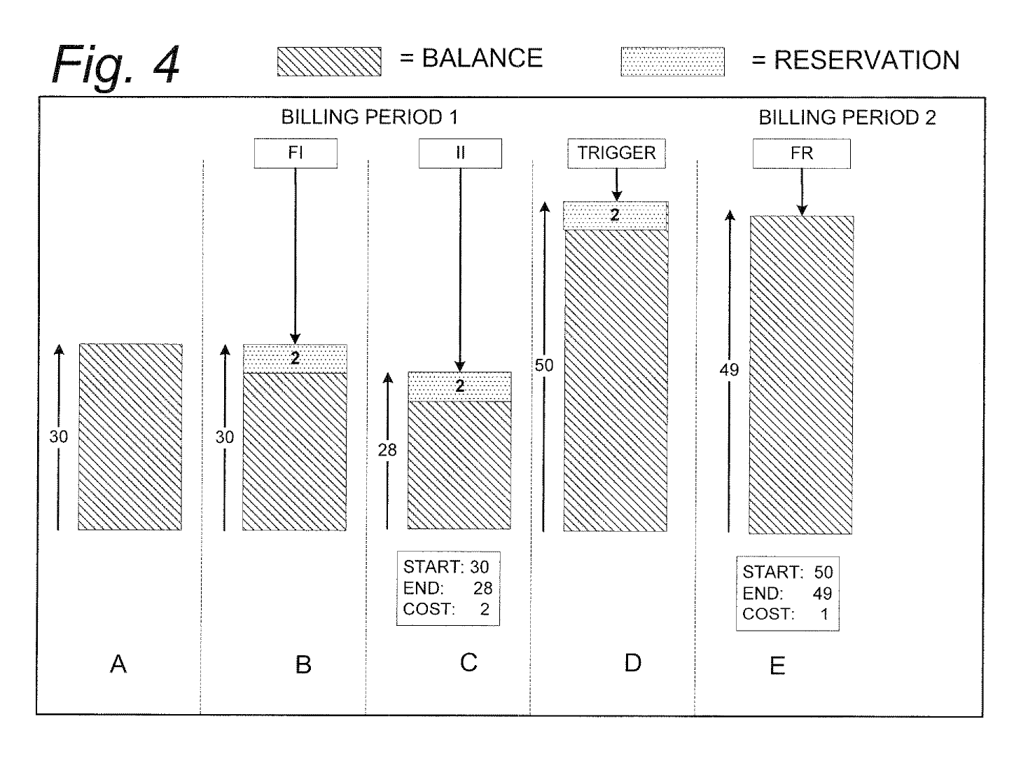

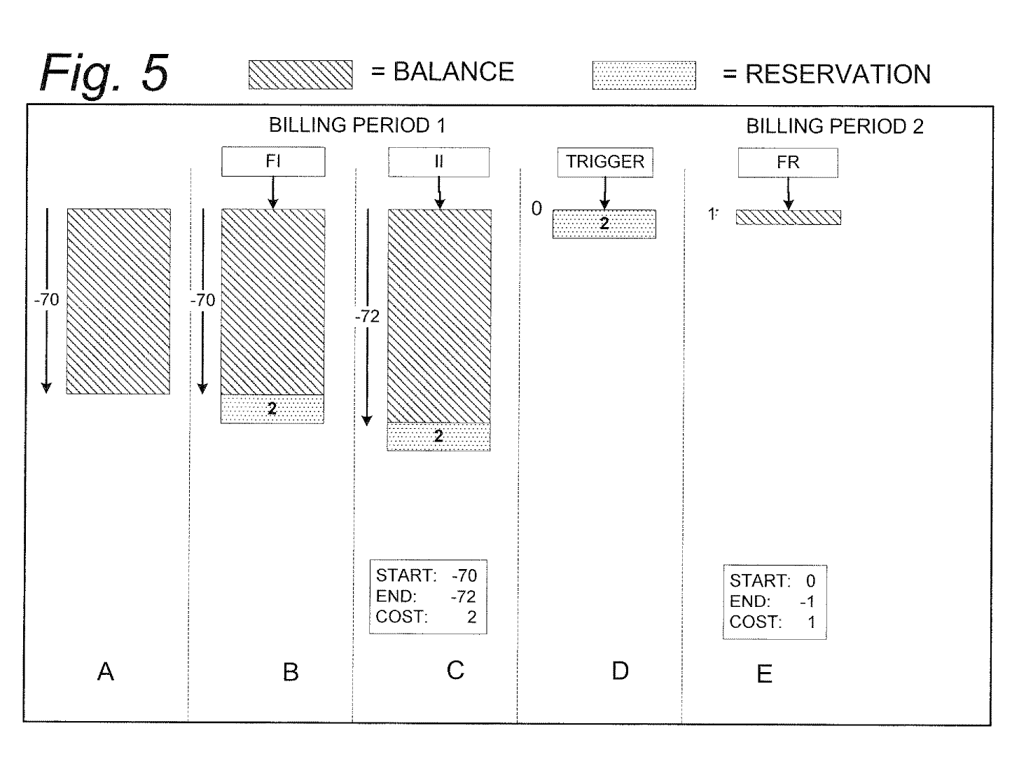

FIG. 4 and FIG. 5 illustrate other scenarios of handling open reservations in a real-time environment which are also understood with reference to, e.g., the acts of FIG. 2. That is, FIG. 4 and FIG. 5 show examples of how to handle ongoing sessions in a real-time environment in relation to period cut-over operations caused by, e.g., periodic bundles or when new credit is given to create postpaid behavior.

In the scenario of FIG. 4, for each billing period the user is provided with a bundle of 50 minutes voice service, represented by money on a dedicated account, given to subscriber each month (a month being a billing period). These kind of bundles are very frequently used, both for pre and post paid subscriptions. Billing period 1 comprises frame A, frame B, frame C, and frame D. The time shown in frame A of FIG. 4 is near the end of billing period 1 (e.g., near the end of the month), and the user has a balance of 30 units.

Frame B of FIG. 4 shows a first interrogation (FI) occurring in conjunction with a call-setup, which involves a reservation of 2 units.

Frame C of FIG. 4 reflects an intermediate interrogation (II), which comprises an evaluation of the existing reservation and a further reservation of 2 units. As a result of the evaluation, the balance in the account becomes 28 units.

Frame D of FIG. 4 illustrates an end of the billing period and invoice generation. The close of the billing period occurs upon receipt of a close of billing period trigger, which also ends the time frame D of billing period 1. In time frame E of billing period 2 a final report interrogation is issued, which prompts for the information of the account to be utilized to generate a bill or invoice for the user. At the beginning of the new billing period (e.g., billing period 2) the account balance is reset to the monthly amount of 50 units, with 2 units still being reserved (for a yet-evaluated reservation).

Frame E of FIG. 4 thus depicts a change over to a new billing period (e.g. billing period 2). At the time that a final report for the session is required (shown in frame E), only one of the two units for the existing but yet-evaluated reservation has been utilized. Therefore, the new balance for the account becomes 49, and the accrued cost for billing period 2 is 1 unit. The outstanding reservation of 1 unit is deleted. Otherwise, funds are or could be improperly moved between periods, which is a result of the set-operation not knowing the outcome of the ongoing sessions).

The scenarios of FIG. 5 reflect a postpaid subscriber who has a negative real-time balance, which is reset each month. Billing period 1 in FIG. 5 comprises frame A, frame B, frame C, and frame D. Frame A of FIG. 5 occurs near the end of the billing period (e.g., near the end of the month), at which time the user of FIG. 5 has a balance of −70 units.

Frame B of FIG. 5 shows a first interrogation (FI) occurring in conjunction with a call-setup, which involves a reservation of 2 units.

Frame C of FIG. 5 reflects an intermediate interrogation (II), which comprises an evaluation of the existing reservation and a further reservation of 2 units. As a result of the evaluation, the balance in the account becomes −72 units.

Frame D of FIG. 5 illustrates an end of the billing period and invoice generation. The end of the billing period occurs upon a close of billing period trigger, which also ends frame D. At the end of the billing period (e.g., billing period 1 of FIG. 5) the information of the account is utilized to generate a bill or invoice for the user. Thereafter the account balance is reset to 0 units, with 2 units still being reserved (for a yet-evaluated reservation).

Frame E of FIG. 5 depicts a change over to a new billing period (e.g. billing period 2). At the time that a final report for the session is required (shown by receipt of a final report interrogation in frame E), only one of the two units for the existing but yet-evaluated reservation has been utilized. Therefore, the new balance for the account becomes −1, and the accrued cost for billing period 2 is 1 unit. The outstanding reservation of 1 unit is deleted.

In the scenarios of FIG. 3, FIG. 4, and FIG. 5, the trigger that closed a billing period was a close of billing period trigger. It should be understood that alternatively either of the billing period trigger 2-2_{BT}, the pre-arranged or pre-negotiated trigger 2-2_{PT}, of the management trigger 2-2_{MT} could have been utilized.

By using the solution described herein it is possible for a billing system to aggregate the cost items and get a balance which is a correct shadow of the balance in the real-time environment. This creates the possibility to indicate cases then data records are lost before aggregated in the billing system. In other words, the system can be synchronized (when the billing system is a shadow).

Thus, in accordance with the technology described herein, balances in a real-time revenue management system and the billing/invoice system can be kept synchronized.

Although the description above contains many specificities, these should not be construed as limiting the scope of the invention but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A method of operating a communications system comprising:
during a communications session involving a user of the communications system, making one or more reservations toward an account for a user, the account for the user being maintained in a real time account record;
upon receipt of a trigger signal, in conjunction with the reservation(s) assessing the account for the user only for the reservation(s) which are evaluated by an interrogation during the billing period;
upon close of a billing period for the session, in conjunction with any yet-evaluated reservation(s):
assessing the account for the user only for a part of the yet-evaluated reservation(s) that is actually utilized; and
deleting from the account for the user any unused part of the yet-evaluated reservation(s).

2. The method of claim 1, further comprising, at the close of the billing period, resetting a balance for the account for the user.

3. The method of claim 1, further comprising:
including plural time frames in the billing period;
evaluating the reservation(s) upon receipt of the interrogation during one or more of the time frames.

4. The method of claim 1, wherein the trigger signal is one of a close of billing period trigger signal, a pre-arranged or pre-negotiated trigger signal, and a management trigger signal.

5. A communications system comprising:
an account database configured to maintain a real time account record for a user of the communications system;
an accounts processor configured:
upon receipt of a trigger signal, to assess an account for the user in conjunction with a reservation(s), the account being maintained in the real time account record;
upon close of a billing period for a session involving the user, and in conjunction with any yet-evaluated reservation(s):
to assess the account for the user only for a part of the yet-evaluated reservation(s) that is actually utilized; and
to delete from the account for the user any unused part of the yet-evaluated reservation(s).

6. The communications system of claim 5, further comprising a communications activity monitor configured to issue one or more interrogations to the accounts processor.

7. The communications system of claim 5, wherein the accounts processor is further configured at the close of the billing period, to reset a balance for the account for the user.

8. The communications system of claim 5, wherein the accounts processor is further configured to include plural time frames in the billing period and to evaluate the reservation(s) upon receipt of an interrogation during one or more of the time frames.

9. The communications system of claim 5, wherein the trigger signal is one of a close of billing period trigger signal, a pre-arranged or pre-negotiated trigger signal, and a management trigger signal.

10. The communications system of claim 5, wherein the accounts processor comprises an account bill/report generator configured to execute a first mode wherein the account for the user is assessed only for the reservations(s) which are evaluated by an interrogation during a same time frame.

11. The communications system of claim 10, wherein the account bill/report generator is further configured to execute a second mode wherein the account bill/report generator:
evaluates the account for the user for the reservation(s), if any, which are initiated by an interrogation during previous time frames;
assesses the account for the user only for a part of the yet-evaluated reservation(s) that is actually utilized;
deletes from the account for the user any unused part of the yet-evaluated reservation; and resets the balance for the account after an invoice or bill has been generated.
